(19) United States
(12) Patent Application Publication
(10) Pub. No.: US 2001/0027413 A1
(43) Pub. Date: Oct. 4, 2001

(54) System, software and method of evaluating, buying and selling consumer's present and potential buying power through a clearing house

(76) Inventor: Hafiz Khalid Rehman Bhutta, Torrance, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/792,525

(22) Filed: Feb. 23, 2001

Related U.S. Application Data
(60) Provisional application No. 60/184,729, filed on Feb. 23, 2000.

(51) Int. Cl. G06F 17/60

(52) U.S. Cl. 705/14; 705/10

(57) ABSTRACT

A unified system, software and methods for facilitating the transaction of business in which consumers, individuals or entities, sell their present and potential buying power to a clearing house or client transaction broker that first buys the buying power from the consumer and then may sell it to various companies and merchants. The clearing house evaluates each consumer's purchasing potential or buying power to determine the type, quantity and the monetary value of the transactions which the consumer will conduct during a given period of time. The buying power or purchasing potential is further used as a basis for determining cash value or compensation that may be paid up-front or guaranteed to be paid according to an agreed-upon schedule, method, type and form of payment. The consumer is presented with an diversified plurality of options for receiving the agreed-upon compensation in exchange for the consumer's obligation to transact with companies and merchants affiliated with the clearing house.

### RELATED APPLICATIONS

This application claims the benefit under Title 35 §USC 119(e) of U.S. Provisional Application No. 60/184,729, filed Feb. 23, 2000.

### BACKGROUND OF THE INVENTION

1. Field of the Invention

The present invention relates to a system, software and a method of creating and operating a clearing house or client transaction broker that is designed for evaluating, analyzing, pricing, buying and selling present and future buying powers of the consumers and other entities.

2. Description of the Related Art

Incentive-driven marketing plans or motivational purchase programs are well known in the prior art. These programs offer various incentives in an attempt encourage consumers to transact with merchants for the acquisition of various goods and services. The commercial transaction success of these plans depends largely on how attractive consumers find the incentive and how broad the consumer base is which the incentive can be applied to.

An exemplary patronage incentive system found in the prior art employs advertisement of sales or discounted prices which the consumer can take advantage of. In a similar manner, coupon issuance or rebate programs can be used to encourage consumer patronage. The incentives offered by these systems are provided when the consumer receives the discount or rebate upon meeting the conditions of the advertisement or presenting the coupon for the good or service offered by the merchant.

Using these incentive-based patronage methods, the consumer is motivated to complete transactions in a timely manner in order to acquire the good or service at a reduced cost. However, a significant drawback results from use of these systems in that there are often large requisite costs incurred by the merchant. Costs associated with advertising sales and discounts or printing of coupons can present a particular problem for merchants that do not have sufficient resources to reach large numbers of potential consumers. Furthermore, these costs financially encumber the merchant prior to any transactions with the consumers and have no guarantee of patronage. Such risks cannot be tolerated by many businesses and more effective methods of acquiring consumers are often sought.

More recently, reward driven programs have been devised to encourage consumer patronage. A typical reward driven program couples the consumer procurement of a product or service with receiving a designated incentive or monetary reward. Additionally, a reward-driven program may encourage consumer patronage through participation in a game or drawing. As with previous incentive-driven marketing plans, these incentives are typically expensive to provide, fail to insure consumer patronage, and do not encourage sufficient consumer loyalty in the absence of the offered incentive.

Another type of patronage incentive system operates using point or credit-based programs, for example frequent flyer mileage programs. In these programs, the consumer accumulates credits by the transacting with participating merchants. The number of points obtainable by the consumer is typically linked to the number of transactions that are made with the merchants. Subsequently, the points or credits can be redeemed for monetary discounts on goods and services or other rewards. A problem encountered when using this system is that the consumer need for immediate gratification often goes unmet. Instead, the consumer must typically wait long periods of time before having a sufficient quantity of points or credits to redeem reducing the effectiveness of the incentive in encouraging transactions. Furthermore, while participating in these programs, not only are the consumers invariably required to spend a substantial amount of money before they are qualified or receive anything of substantial value but often times consumers end up spending more than their means or, worse yet, get buried under debt.

An underlying similarity shared by each of the aforementioned motivational purchase programs resides in the manner in which the incentive is obtained. In each case, the incentive is obtained during, or subsequent to, the time of transaction with the merchant. The resulting incentive structure, based on rewarding consumers for purchases only after a transaction has been made, does not significantly improve consumer loyalty in the long term. Such a system is easily overcome by competing merchants that may offer slightly increased incentives for similar goods or services. Furthermore, this manner of motivating consumer spending is inefficient as the consumer must be continually enticed into making purchases by offering new incentives on subsequent purchases.

Another drawback found in many existing incentive-driven marketing plans is the rewards offered to the consumer do not have a lasting or significant impact on the consumer's lifestyle and are thus less effective in encouraging consumer transactions. For example, most incentives are offered by merchants through individual channels or separate programs. As a result, the value of the incentive is necessarily diminished as it reflects incentives offered by one merchant or small group of merchants with which the consumer transacts. Also, these incentive programs are typical inflexible in nature and offer only a single type or category of incentives. As a result, many existing incentive-based programs cannot always capture the interest of the wide spectrum of consumers who are likely to transact with a particular merchant.

Other patronage incentive systems have been developed which promote longer term benefits to the consumers. For example, systems have been described which accumulate monetary incentives in a consumer's savings or retirement account. These systems attempt to combine relatively small incentives in such a manner so as to promote their growth over longer periods of time and thus create a greater reward for the participant. A drawback encountered when using these systems occurs as a result of the participant having to wait for long periods of time to gain any significant benefit from the patronage incentive program. Another disadvantage of such a system is that even if the clients participated in a reward for a long period of time, only a very small percentage of clients total income is being spent with that particular merchant, therefore, even the long term rewards not substantial. These kinds of systems that may rely on only long-term incentives lack the ability to compensate the participants in a timely and substantial manner. Timely and substantial rewards or incentives are important in insuring consumer interest in the incentive program and providing the sense of “immediate gratification” which many consumers have grown accustomed to. Additionally, the limited scale and scope of these programs fail to generate any guaranteed or worthwhile financial rewards that the clients can count on with any great degree of certainty.

Another major disadvantage with existing rewards or incentive-based programs is that these programs reward the clients only in bits and pieces and limited ways, e.g. clients may be required to buy certain products or services, from a certain place, at a certain time, spending a certain amount of money, using a certain method of payment and with the potential for many other restrictions and inconveniences.

Another problem with existing motivational purchase programs is that these programs do not provide sufficient methods to assess and compensate participants based on their individual financial profiles. It is important to not only offer incentives to a consumer, but also, to tailor the incentive to match the purchasing potential of the consumer. For example, in an incentive-based program where the incentive is identical for each participant, a consumer with greater financial resources may find a particular incentive program less appealing as the potential rewards are insignificant relative to his current financial situation.

The foregoing incentive-driven marketing plans and motivational purchase programs are merely methods of doing business and do not address the need for a system which facilitates the effective compensation of customers in a flexible and highly-desirable manner. Furthermore, it can be appreciated that there is a need for a system which offers increased benefits that are substantial and guaranteed. These benefits should not inconsequential and can significantly impact the consumer's financial outlook both presently and in the future. Additionally, these benefits should be provided simply for transacting with an organization, regardless of whether the transaction is paid by a credit card, debit card, check, cash or through some other financial instrument. Furthermore, these benefits should be customizable to accommodate a variety of incentive or reward opportunities for the consumer. The incentive system should be structured so as to provide both short-term and long-term choices for compensation to meet the needs of many different consumer profiles. Additionally, there is a need for a motivational purchase program that can assess the financial resources of a potential consumer and offer customized incentives to the participant prior to transacting with the merchant.

### SUMMARY OF THE INVENTION

The aforementioned needs are satisfied by an invention that comprises a unified system, a software and/or a method for creating and operating a business that in one aspect can be called a clearing house or a client transaction broker that is designed for 1) evaluating, analyzing, pricing; 2) buying and selling the present and future buying powers/influencing powers of the consumer/entities; and 3) unifying a system and methods for transacting business and managing incentive-driven commerce wherein consumer buying power is sold to affiliate merchants and used as a vehicle for leveraging and gaining maximum returns. The system incorporates an organization, clearing house, or client transaction broker (CTB) that evaluates for a plurality of consumers who might be interested in selling their present and future buying power.

This system may benefit the consumer both in the short term, as well as, the long term and recognizes the significance of the consumer's purchasing or buying power by compensating the consumer for his willingness to sell this purchasing power. The system incorporates an organization or client transaction broker (CTB) that evaluates a plurality of consumer participant's present and future buying power. In one aspect, the CTB may buy the consumer's present and future purchasing power or buying power from the consumer. Furthermore, the CTB may buy purchasing power from consumers and sell it to merchants. The consumer benefits from this transaction by receiving the up front payment and/or guarantee of a certain amount of monetary value in exchange for selling their buying power.

A consumer's buying power reflects an aggregate of financial variables that are analyzed, by studying past purchasing patterns (ppp) to assess how the participant will most likely conduct mercantile activity with one or more merchants in the future. Each consumer's purchasing power is rated. Rating is based on many factors including: potential profitability, size/amount of buying power, duration of commitment, past purchasing patterns (ppp), how-when-where and on what type of products and services the consumer will/is likely to spend, and what percentages of their total buying power they are willing to sell. The consumer's buying power is then given a certain score, similar to a FICA score. Each buying power score carries an amount of cash value, based on the actual cash value of a calculated consumer's buying power. Following the buying power assessment, the CTB calculates the cash value of consumer's buying power, in terms of number of dollars. CTB then informs the participant about cash value of his/her buying power. The CTB, simultaneously, presents the consumer participant with a variety of options or choices that reflect various forms and plans about how the consumer can get paid for selling his/her buying power. Depending on a variety of factors related to consumer's finances, needs, obligations, resources, preferences, and many other relevant factors, the consumer may be presented with the option to immediately take all or part of the compensation he/she has been promised. Consumers are also given numerous other options where they can get paid according to a time schedule, at a certain agreed upon point of time, invest in the company or other stocks, contribute towards retirement, save for education, give to charity, and so on.

Each consumer that takes advantage of this opportunity, is issued a membership identifier or identification which can help affiliate merchants and the CTB to identify the consumer and keep a track of their transactions. The consumers are likely to benefit from almost every transaction they make with the affiliate merchants, even when it is by cash, check, credit, debt card etc, which is one of the many distinctions of this system.

One advantage of the buying power assessment is that it allows the CTB to offer each participant a customized compensation package in which the participant can receive the benefit of future purchase commitments prior to the actual purchase of the goods and services. The buying power assessment further provides a method for the CTB to offer the participant a larger incentive than is practical using conventional promotional methods.

In one aspect, the system and method for transacting business is based, in part, on leveraging the present and future buying power or purchasing power of the consumer. In exchange, the CTB offers an up-front guarantee of compensation that satisfies short-term and/or long-term financial needs. The value of participant compensation is also increased by unifying merchant incentive offerings wherein the participant may transact with a plurality of merchants affiliated with the CTB to reflect combined transaction activity to be considered for compensation. The affiliated merchants likewise benefit from the arrangement through knowledge of the quantity and types of transactions that they can expect to receive. Transaction knowledge is obtained as a result of the CTB forming an agreement with the participant wherein various levels of spendings, the number, and/or the type of transactions that will be made during the consumer enrollment in the program is pre-determined.

This system/software will create a network of merchants and link them to the CTB. It will also monitor, manage and store the particulars of the reported transaction, carried out by the consumer with the affiliate merchants, whether that transaction is paid by credit card, debt card, check, cash or any other method of payment.

In one aspect, the system and method for transacting business comprises: (1) Enrolling a plurality of participants with the organization or CTB; (2) Determining a buying power “BP score” for the consumer(s), based on their PPP, and assigning a cash value to the estimated aggregate of the total purchasing power of the plurality of participants based on their PPP and anticipated mercantile activity; (3) making any up-front payment(s) that may be equal to cash value of the PP or a part thereof, and/or presenting the clients with various other options available to optimize the use of cash value received from the sale of their buying power; (4) Contracting and creating a network of one or more affiliates or merchants will agree to buy, from the CTB, a part or all of the consumer's buying power for a certain price. In return the merchant becomes an affiliate of the CTB and provides services/products to the clients; (5) Providing the participants with a list of companies and/or affiliate merchants and obligating the affiliated to provide a return dividend to the organization in exchange for the mercantile activity of the participants; (6) Obligating the participants to engage in mercantile activity with the one or more affiliates; (7) Selling the consumer's buying power to the affiliate merchants, receiving return dividends from the sale of the buying power and using at least a part of the received proceeds/return dividends to pay/offset the purchase price of the buying power that has been paid or committed to be paid to the consumers; (8) Distributing compensation dividends from the organization to the participants in exchange for their mercantile activity; and (9) Analyzing the relationships and variations of the consumer mercantile activity or past purchasing patterns (PPP). These factors may relate to what the consumer had committed to transact through the CTB (called promised mercantile), and what the consumer actually transacted through the CTB (called actual mercantile). (10) Informing the consumers and/or merchants of any adjustments and evaluations; (11) In the event that consumer transacted less than he/she had committed to, but had already received a part or all of proceeds due from the sale of his/her buying power, he/she may be asked to pay back a proportionate amount of money to the CTB, due to the negative balance; (12) Creating optimized returns or compensation dividends for the consumer; and (13) disbursement of the returns or compensation dividends.

In the aforementioned method for transacting business, the return dividend is calculated using the estimated aggregate of the total purchasing power of the participant. Furthermore, at least a portion of the return dividend received by the organization is used to offset the cost of providing compensation to the participants.

A computerized system for transacting business is also described which uses the aforementioned system and methods for conducting business. The computerized system comprises software components which acquire information about the consumer participant and use this information to determine the total buying power or purchasing power of the participant. Furthermore, the software has functionality to determine the compensation dividend to be provided to each participant in exchange for an estimable quantity of mercantile activity.

### BRIEF DESCRIPTION OF THE DRAWINGS

These and other objects and advantages will become more fully apparent from the following description taken in conjunction with the accompanying drawings which are meant to illustrate and not to limit the invention, and in which:

FIG. 1 is a block diagram illustrating a system for conducting incentive driven commerce.

FIG. 2 is a block diagram illustrating the components used to evaluate consumer purchasing potential.

FIG. 3 is a block diagram illustrating exemplary components used to determine diversified participant compensation.

FIG. 4 is a block diagram illustrating exemplary consumer benefits for compensating the participant.

FIG. 5 is a flowchart illustrating a participant enrollment process.

FIG. 6 is a flowchart illustrating a participant maintenance process.

FIG. 7 is a block diagram illustrating exemplary components of a computerized client transaction broker.

### DETAILED DESCRIPTION OF THE PREFERRED EMBODIMENT

Reference will now be made to the drawings, wherein like numerals refer to like parts throughout.

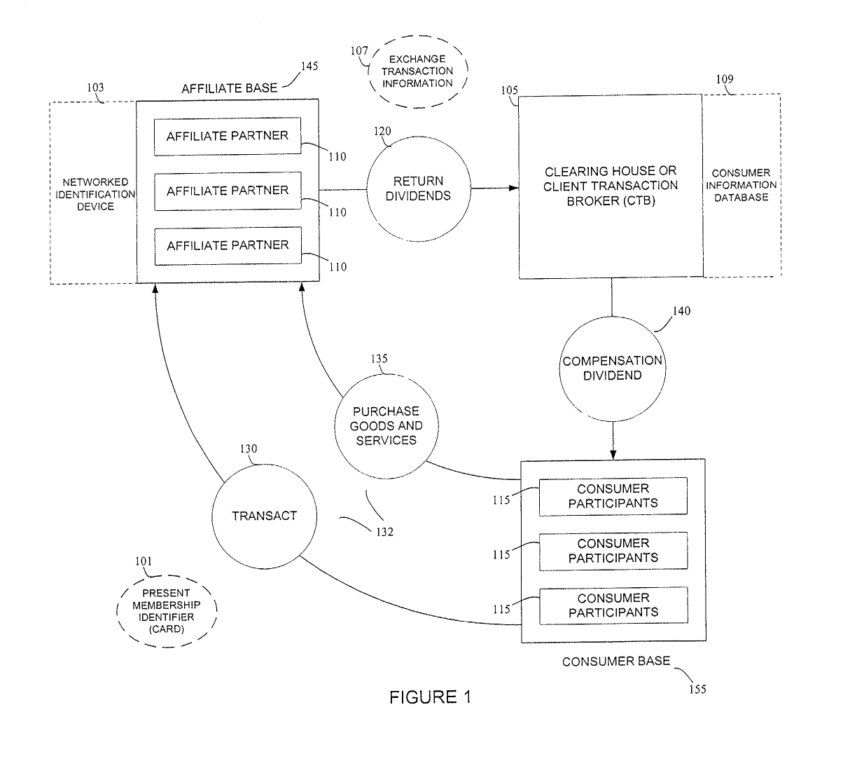

FIG. 1 illustrates an overview of a system for conducting incentive-driven commerce or transacting business. The incentive driven commerce system is implemented using a client transaction broker (CTB) 105 that facilitates and improves commerce conducted between affiliate partners 110 and consumers 115. In one aspect, the CTB 105 is an organization or clearing house that improves commerce by organizing a plurality of consumers 115 comprising a customer base 145 which preferentially transact with the affiliate partners 110 associated with the CTB 105. The CTB 105 further improves commerce by providing incentives or compensation dividends 140 to the consumers 115 in exchange for their agreement to transact with the affiliates 110 associated with the CTB 105. The CTB 105 may therefore serve as an intermediary and administrator of the patronage incentive program for consumer 115 interested in leveraging their present or future buying power. The CTB 105 desirably posses the necessary functionality and resources to desirably benefit each of the interacting components as will be discussed in greater detail hereinbelow.

The association of the CTB 105 and affiliate partners 110 is predicated upon an agreement of terms or conditions through which the affiliate partners 110 return dividends 120 to the CTB 105. The return dividends 120 of the affiliates 110 typically take the form of monetary compensation, however, other dividends may be provided which include equity shares in the company, stocks, services, goods, and the like. In exchange for return dividends 120, the CTB 105 provides the affiliate partners 110 with consumer participants 115 which have agreed to conduct mercantile activity or commerce 132 with the merchants or affiliates 110. The mercantile activity 132 may further comprise transacting with 130 or purchasing goods and services 135 from the affiliates 110.

In one aspect, commerce is maintained between the participants 115 and the affiliates by the CTB 105 which may already have paid an agreed-upon price or may have agreed to pay according to a plan of compensation 140 for the participants 115 in exchange for their commitment to perform the transactions 130 or purchase the goods and services 135 from the one or more affiliates or partners 110 which make up the affiliate base 145. The nature of the consumer compensation 140 may take many forms including immediate incentives, as well as, longer term incentives which reward the participant 115 for his patronage, at an agreed upon time or over an extended period of time.

A distinctive feature of the method for improving commerce that may be used by the CTB 105 is the manner in which the participant is compensated. In this method, the CTB 105 may desirably provide the participant 115 with the compensation dividend 140 prior to transaction with the affiliates 110. Additionally, other details including the amount, time, type and method of the compensation 140 may be customized for each participant 115 based on several determining factors.

One such factor is the willingness of the consumer 115 to transact with the affiliates 110 and reflects the consumer's desire to leverage his present and future buying power. Each consumer 115 typically has different transaction needs and desires that can be met by individual partners 110 of the affiliate base 145. Furthermore, the consumers 115 may also have some preferences about the manner, time and details relating to receiving the agreed upon compensations. The consumers 115 may also desire to transact with particular merchants or partners 110 for goods and services which are commonly available. The CTB 105 recognizes that each consumer 115 with therefore likely have individualized profiles for mercantile activity 132 and takes this factor into account when determining the type and quantity of compensation 140 to offer to the consumer 115.

Another factor relates to the prospective ability of the consumer 115 to make various types of transactions. In one aspect, this ability is gauged by evaluating various aspects which are unique to each participant 115. These aspects may be related to the participant's social status, lifestyle, habits, and obligations.

The CTB 105 desirably acquires information about the participant 115 to identify these aforementioned determining factors to create an assessment of the aggregate buying power or purchasing potential of the consumer 115. The purchasing potential of the consumer or buying power 115 desirably reflects both short-term and long-term estimates of the consumer's transactions and may serve as a basis for determining the quantity, amount, type, and method of compensation which might best serve the consumer 115 as will be discussed in greater detail hereinbelow.

In one aspect, a client transaction broker system for implementing the abovementioned associations and interactions for transacting business comprises a plurality of membership identifiers 101 which uniquely identify each consumer participant 105. The participant 115 desirably presents or provides the affiliate partner 110 with the membership identifier 101 so as to permit the affiliate partner 110 to recognize the participant 115 as being associated with the CTB 105. The membership identifier 101 may further comprise an encoded identification card, membership card or account number which identifies the participant 115 to the affiliate 110 and is presented at the time of mercantile activity 132.

A plurality of networked identification devices 103 are distributed to each of the affiliate partners 110 permitting the affiliate partners 110 to quickly identify the participant and exchange transaction information between the affiliate partner 110 and the CTB 105 using the abovementioned membership identifiers 101. In one aspect, upon receiving the membership identifier 101, the affiliate partner 110 may use the networked identification device 103 to interpret the membership identifier 101 and access information about the consumer participant 115. In the example of the encoded identification card or membership card the affiliate partner 110 uses the card in conjunction with the networked identification device 103, comprising a membership card reader, to identify the participant 115 and to record and transmit mercantile activity 132 conducted by the participant 115 to the CTB 105.

Transaction information exchange 107 between the clearing house or CTB 105 may subsequently be used to facilitate the administration and management of mercantile activity 132 and return dividends 120. In one aspect, the transaction information exchange 107 determines the amount or quantity of return dividend 120 which is owed to the CTB 105 by the affiliate partners 110 based on the amount of types of transaction conducted by the participants 115.

Additionally, the information exchange 107 may be used to update a consumer information database 109 comprising a plurality of records for each of the consumer participants 115 maintained by the CTB 105. The consumer dividend database 109 may desirably store information about the participant's mercantile activity 132 and provides a consumer transaction history which contains the information related to each transaction. The consumer transaction history can further be used by the CTB 105 to determine the compensation dividend 140 which is owed to the participant 140 or to monitor consumer compliance with the terms and conditions set forth by the agreement between the consumer 115 and the CTB 105. Information contained in the consumer information database 109 may also be used to monitor return dividend 120 exchange between the affiliate partner 110 and the CTB 105 to insure that each partner 110 provides the CTB 105 with appropriate and timely return dividends. Another important aspect of the monitoring of the acquisition of return dividends 120 is resultant from the desirable use of the return dividends 120 to fund the compensation dividends 140 offered by the CTB 105 to the consumer participant 105.

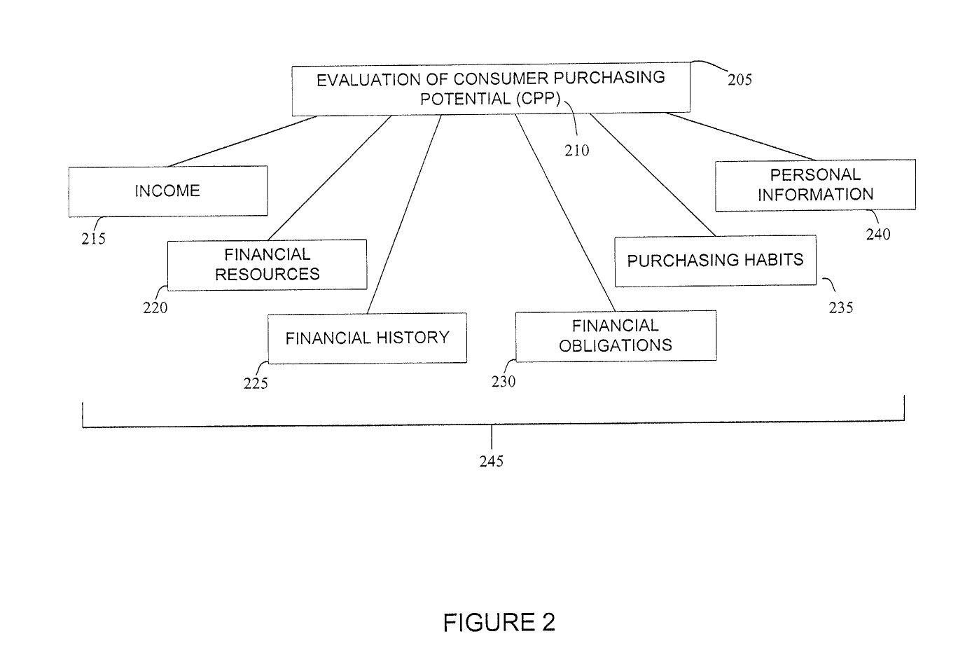

FIG. 2 illustrates exemplary considerations or consumer factors 245 used by the CTB 105 to evaluate 205 consumer purchasing potential (CPP) 210. These considerations are desirably assessed both individually and collectively to provide the CTB 105 with an index as to the quantity, method and type of transactions the participant 115 will be engaged in with the affiliates 110. By evaluating the CPP 210, the CTB 105 may also accurately determine the quantity, amount, type, and method of incentives that are appropriate for each participant 115. In one aspect, factors 245 such as income 215, financial resources 220, financial history 225, and financial obligations 230 and other relevant factors may provide a foundation for constructing a detailed financial prospectus of the participant 115.

Evaluation of the participant's income 215 may comprise evaluating both present and past income levels, as well as, considering future earning potential. This information is desirably assessed in conjunction with the financial resources 220, such as, for example, bank accounts or retirement plans of the participant 115. The combined information is therefore a reflection of the amount of money which the participant 115 has, may have, will have or will likely have available for subsequent transactions with the affiliates 110.

In addition to the available resources the participant 115 may have, it is also desirable to assess the financial obligations 230 and financial history 225 of the participant 115. This information affects how much available income the participant may have and provides information on the types of transactions the participant 115 has made in the past. Using this information the CTB 105 may determine the types of affiliates 110 the participant 115 may be interested in interacting with.

The CPP 210 may further comprise additional information regarding the purchasing habits or past purchasing patterns (PPP) 235 of the participant 115 and other personal information 240. The CTB 105 uses this information to evaluate potential interest in the affiliates 110 and as a basis for determining the type and amount of compensation 140 the participant 115 should be offered. In one aspect, the CTB uses the aforementioned consumer factors to generate a score or rating of the consumer's purchasing power or CPP 210. This score can desirably be used to facilitate the determination of the form of compensation or incentive which the consumer 115 will receive in exchange for leveraging his buying power. In another aspect, the CPP 210 is a method for assigning a monetary or cash value to each consumer's purchasing potential which can further be used to determine an appropriate dividend or incentive to provide the consumer with.

It will be appreciated that evaluation 205 of the CPP 210 may be a complex process with many different contributing factors 245 and not necessarily suitable for assessment by hand. Therefore, evaluation of the CPP 210 can be improved by using the aforementioned client transaction broker system to evaluate a consumer participant's purchasing potential or buying power 210 to determine an appropriate compensation dividend 140. The client transaction broker system may which takes as input the information and factors 245 required to calculate the CPP 210 and returns a customized assessment of the CPP 210 automatically. Furthermore, the client transaction broker system may use the customized assessment of the CPP 210 or the contributing factors 245 to identify candidate affiliates 110 of the affiliate base 145 which the participant 115 will likely wish to transact with. Additionally, the client transaction broker system may calculate appropriate incentives based on the aggregate of the CPP 210 or consumer factors 245. One or more choices or options for incentives or dividend compensation 140 may then be provided for the participant 115 which may be selected from as will be described in grater detail in subsequent illustrations.

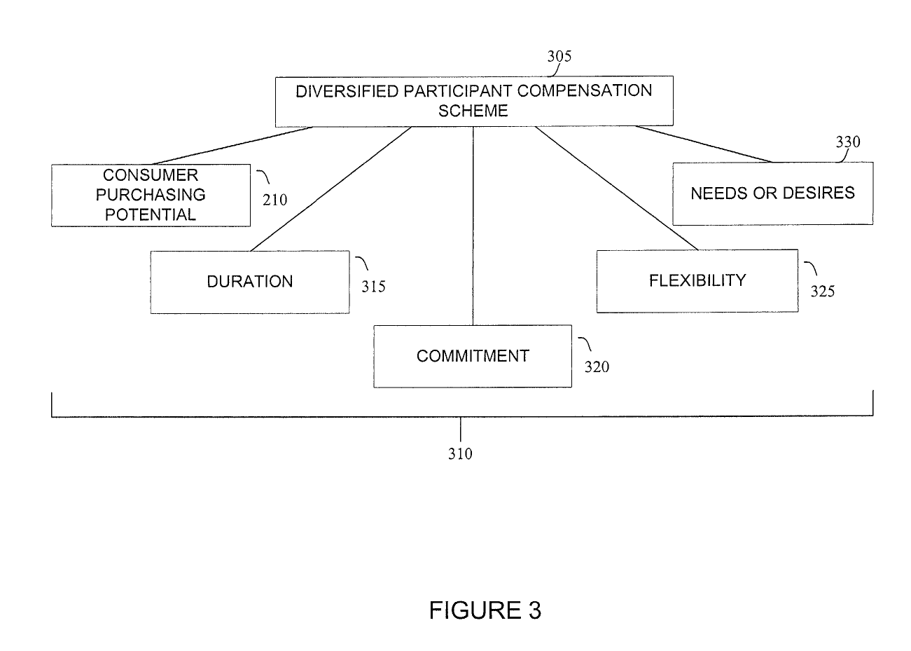

FIG. 3 illustrates a diversified compensation scheme 305 used by the incentive-driven commerce system. The compensation scheme 305 is an improvement over may existing methods and may be customized for each participant 115. In this scheme 305, a highly flexible approach to compensating participants 115 is utilized which provides participant's with a wide variety of compensation options based on a plurality of compensation factors 310. In conventional systems, incentives typically offered to induce consumer patronage are limited with respect to the type of incentive the consumer can select from. This results in reduced effectiveness of the incentive and typically creates an incentive that does not have uniform appeal to all potential consumers.

One underlying principle of the diversified compensation scheme 305 is to present the participants 115 with different choices and forms of compensation 140 which can be selected from based on individual preferences and consumer eligibility. In one aspect, the compensation scheme 305 uses the plurality of contributing factors 310 which include the aforementioned CPP 210 to determine how many transactions or how much money may be spent by the participant 110 in conducting business with the affiliates 110. The CTB 105 may also consider other contributing factors such as: (1) The duration of time 315 for which the participate 115 will be involved in the program; (2) The level of commitment 320 the participant 115 is willing to pledge or obligate to; (3) The degree of flexibility 325 the participant has with respect to transactions which will be conducted with the affiliates 110; (4) The participant needs or desires 330 which may determine the kinds of transactions or mercantile activity 132 the participant 115 will likely engage in with the affiliates 110; (5) The proximity of the participant to the merchant; and (6) Other relevant factors.

The CTB 105 uses the aforementioned contributing factors 310 to determine the type and amount of compensation 140 and the type of program which is appropriate for each participant 115. The compensation 140 is further based to a certain extent on the degree to which the affiliates 110 will benefit from the participant's transactions. For example, a wealthy retired individual who typically engages in numerous recreational activities and travels frequently may have different spending habits compared to that of a young student who has just entered college. Furthermore, the types of compensation that the retiree would find beneficial are likely to be different from that of the student. Thus, the CTB 105 assesses each participant 115 and the aggregate total of his purchasing power in an independent manner. The compensation 140 can then be tailored for each participant to provide the most appropriate or enticing dividends.

In another aspect the CTB 105 uses the contributing factor analysis scheme 305 to determine which businesses or affiliates 110 the participant 115 will likely desire to transact with. Using the example of the retiree and the student, it can be appreciated that the retiree will have different spending habits from that of the student. Thus, the CTB 105 can assess which types of affiliates 110 should be associated with the participant 115 to improve the quantity of transactions conducted. The diversified compensation scheme 305 also benefits the CTB 105 resulting from the increased dividends which can be expected to be generated by the directed association of affiliates 110 and participants 115.

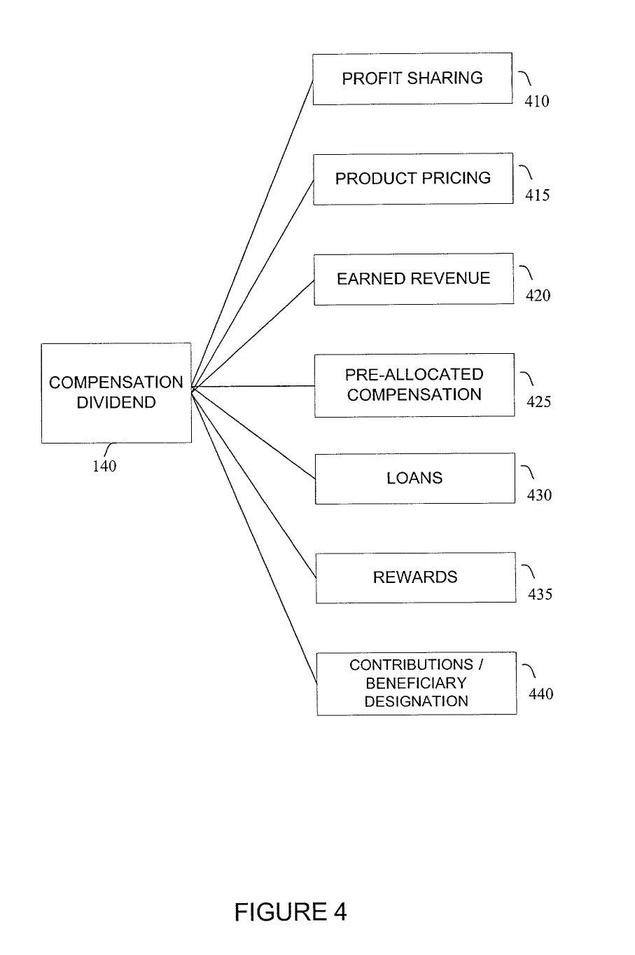

As previously discussed, providing a flexible compensation feature improves the incentive-driven method of commerce. FIG. 4 illustrates possible consumer benefits or incentives which the CTB 105 may present to the participant 115 as forms of compensation 140. The exemplary compensation dividends 140 include profit sharing 410, product pricing 415, earned revenue 420, pre-allocated compensation 425, loans(guaranteed, collateral or others) 430, rewards 435, and contributions/beneficiary designation 440. In one aspect, the compensation dividends 140 may take the form an immediate incentive in which the CTB 105 provides the participant 115 with the compensation 140 prior to transacting with the affiliates 110. Additionally, the compensation dividends 140 may represent longer-term benefits that accumulate or increase in value over time. To receive the benefit of the compensation dividend 140, the participant 115 is obligated to subsequently conduct a certain quantity or type of transactions or spend a certain amount money with the affiliates 110 within a specified period of time.

In one aspect, and as one of the options of payments to the consumers, the compensation dividends 140 may be desirably arranged and combined as agreed upon by both the CTB 105 and the participant 115 where the participant 115 may receive compensation in the form of a guaranteed single sum payment of money, goods, or services based on the number of transactions conducted with members of the affiliate base 145. In one aspect, the compensation 140 is financed through return dividends 120 provided by the affiliate base 145 to the CTB 105. In the incentive-driven commerce system the plurality of participants 115 in the consumer base 155 interact and transact with the plurality of partners 110 in the affiliate base 145. Additionally, the affiliates 110 agree to pay to CTB, an agreed upon price/dividends, in return for a portion of the proceeds obtained from participant's mercantile activity 132 with the affiliate merchants. The portion of the proceeds returned to the CTB 105 by the affiliates 110 may be: (1) A fixed or variable percentage of the proceeds of the consumer transactions. (2) Based on the volume of participant patronage experienced by the affiliate. or (3) Some other mutually agreed upon amount related to the mercantile or participant activity. The CTB 105 uses at least a portion of the return dividends 120 to provide or pay for the compensation dividends 140 each participant 115 is entitled to.

As previously discussed, the participants are permitted to make different choices as to how each wishes to receive the agreed upon purchase price, paid to them for transacting with the affiliates 110. In one aspect, the different types, methods and amount of compensation 140 that will be provided at different times to the consumers, will permit the CTB 105 to invest or leverage at least a portion of the return dividends 120 to accumulate additional value so as to permit the CTB 105 to receive a portion of the dividends 120 while at the same time providing the necessary compensation to the participants.

The compensation dividend 140 of profit sharing 410 may comprise distributing a portion of the return dividend 120 received by the CTB 105 to each of the participants 115. The portion received by each participant 115 may further depend on the amount of compensation 140 which is agreed upon by both the participant 115 and the CTB 105. In one aspect the consumers have the choice to invest in the CTB 105, purchase stock or acquire equity ownership in the CTB 105 and may receive a percentage dividend from the CTB 105. Thus, this benefit may provide both short-term and long-term options for compensation 140 and can be customized to meet the desires of the individual participants 115.

The compensation dividend 140 of product pricing 415 may comprise a benefit wherein the participant 115 receives a fixed, minimum, or discounted price for the goods or services offered by the affiliates 110. This discount may be applied both at the time of sale or as a rebate or incentive return subsequent to the transaction with the affiliate 110. In one embodiment, the discount is applied automatically by the affiliate 110 without the need for the participant 115 to present coupons or fill out forms to obtain the benefit. The CTB 105 may further facilitate this process by maintaining a database of participants 115 whose information is shared with the affiliates 110 to facilitate identification of participants 115 and aid in automating the product pricing 415 benefit.

In one aspect the participant's 105 compensation 140 may be adjusted in proportion to the amount of money spent and or the number and types of transactions carried out by the participants 105. Transactions paid by cash, checks and other types of financial instruments, the debt and credit cards, etc may also be credited towards each participant's compensation calculations. Transactions may be tracked through the combination use of the system, transactional apparatuses used by the merchants, participant's identifiers, password/codes, expense cards, and reporting through other conventional, electronic, cryptographic means.

The compensation dividend 140 of earned revenue 420 may comprise a benefit wherein the participant 115 may be compensated based on the number and type of transactions conducted. For example, using this benefit the participant 115 may “earn” money for shopping at an affiliate store or using the services of a doctor or dentist who is an affiliate 110 of the CTB 105. Thus, the participant 105 may receive incentives in proportion to the amount of transactions that are conducted with members of the affiliate base 145.

In another aspect, the CTB may also use viewing power and polling/opinion consents to leverage the financial gains for its consumers by providing a guaranteed audience for a certain event or activity. Such activities can be monitored through TV and Internet-related monitoring devices and software packages.

The compensation dividend 140 of pre-allocated compensation 425 may comprise a benefit wherein the participant may be compensated by the CTB 105 prior to conducting any transactions with members of the affiliate base 145. Thus, the participant 115 may receive an up-front sum of money or credit with the agreement that he will conduction a certain level or type of transactions with members of the affiliate base 145. Providing the participant 115 with compensation 140 prior to agreed upon commercial transactions can be a powerful and useful incentive for the participant 110 where he may benefit from the compensation 140 immediately and subsequently fulfill his obligation to complete the terms of the compensation agreement.

In a similar manner, the compensation dividend 140 of guaranteed loans 430 may comprise an agreement by the CTB 105 to offer the participant 115 a pre-approved loan immediately or some time in the future. The participant may also be granted guaranteed, collateral and other types of loans against the present and/or future accumulated value of his account with CTB 105. Furthermore, the terms of the loan 430, such as the interest rate, payment schedule, and collateral requirements may be presented to the participant 115 and reflect a discounted loan in exchange for agreed upon consumer patronage. In one aspect, the amount, type, duration, and interest rate of the loan may be further customized for each participant 115, based on the CTB 105 evaluation of the participant's CPP 210. Thus, the CTB 105 can balance the risk of offering guaranteed loans 430 by using the participant's CPP 210 as a basis for determining the amount of the loan 430. Furthermore, the CTB 105 may use the evaluation of the consumer purchasing potential 205 to determine the types and terms of the loan that the participant 115 will find desirable. By compensating 140 the participant 115 with the guarantee a loan, the CTB 105 frees the participant 115 from the anxiety and troubles associated with conventional loan application and qualification processes.

The compensation dividend 140 of rewards 435 may comprise a benefit wherein the participant 115 may receive compensation in the form of a guaranteed single sum payment of money, goods, or services based on the number of transactions conducted with members of the affiliate base 145. The participant 115 and the CTB 105 will desirably agree upon the distribution of the rewards 435 when the participant 115 enrolls in the program. As with other consumer benefits, the participant 115 is obligated to conduct a number of transactions with the affiliates 110 in order to receive the rewards 435.

The compensation dividend 140 of contributions and beneficiary designation 440 may comprise a benefit wherein the participant 155 directs compensation to another individual or entity designated by the participant 115. For example, the participant 115 may elect to have a fund or account set up for another family member wherein the CTB 105 deposits money, derived from transaction compensation 140, directly into the fund or account. Additionally, the participant 115 may designate an organization or charity to receive at least a portion of the compensation 140. Thus, this compensation dividend 140 provides a method by which not only the participant 115 can benefit from the compensation 140 but other individuals may also receive compensation 140 in exchange for the participant's cooperation in transacting with the merchants of the affiliate base 145.

An example of how a participant 115 may elect to receive the compensation dividend 140 may be that the consumer decides to receive an up-front sum of $10,000 in exchange for his total present and future buying power determined by the CTB 105. Alternatively, the participant 115 can agree to a compensation dividend distributed at a later period of time, for example $50,000 in 20 years or wait for 20 years and then receive $1,000 a month for 10 years and so on. In this manner, the CTB 105 may desirably present the participant 115 with many alternative options which may be beneficial to the participant, based on the participant's willingness to sell his present and future purchasing power.

It will be appreciated that many possible embodiments of the compensation dividend 140 exist which may supplement or replace the aforementioned benefits. The duration of the compensation dividend 140 may likewise be short-term or long-term and may also be deliverable prior to, during, or after the time which the participant 115 transacts with the affiliates 110. Thus, other compensation dividends may be used in conjunction with the system and methods described herein to promote enhanced incentive driven commerce.

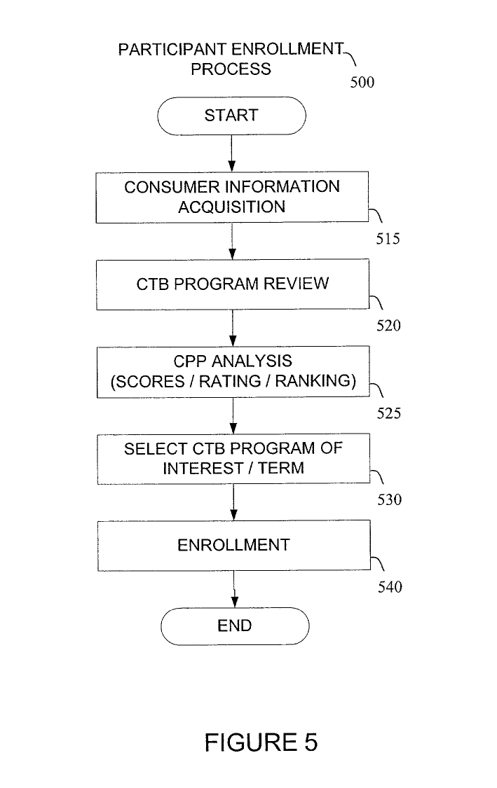

FIG. 5 illustrates a method by which the CTB 105 can implement a participant enrollment process 500 using the aforementioned concepts of CPP evaluation 205 and compensation 140 to improve commerce between the participants 115 and the affiliates 110. The process 500 begins with an acquisition of consumer information 515 wherein the prospective participant 115 provides the CTB 105 with information used to register the participant 115 in the incentive program. In one aspect, the participant 115 provides information used to assess the buying power and cash value of consumer participants purchasing potential or buying power 205.

After providing appropriate personal information, the participant 115 then reviews the CTB incentive program 520. In this state 520, the CTB 105 presents the participant 115 with the contract details and various methods or options of compensation provided by through this system. In one aspect, the participant may review a contract which he will be obligated to in exchange for receiving the compensation dividend. Furthermore, the CTB 105 may desirably describe how the incentive system operates and the available forms of compensation or benefits 140 which the participant 115 may take advantage of.

Subsequently, the CTB 105 may perform a CPP analysis 525 to evaluate the compensation dividend 140 the participant 115 is qualified for. In one aspect, the CPP analysis 525 comprises generating a score, rating, or ranking which is representative of the consumers purchasing potential and may be used to facilitate the determination of the form of compensation or incentive which the consumer will be present with. As previously indicated, the participant enrollment process 500 and, more particularly, the CPP analysis 525 may be automated using a computerized system. The computerized system uses the consumer information to generate a detailed breakdown of the CPP 210 and types of compensation 140 which the participant 115 is eligible for. A more detailed discussion of the various aspects and functionality's of the computerized system will be discussed in subsequent illustrations.

After the participant 115 has been evaluated 525 and informed of the potential compensation options 140, the participant 115 proceeds to select an available CTB program of interest 530. Furthermore, a term or duration for which the participant 115 will be committed to the incentive program is agreed upon with the CTB 105. In one aspect, the customer's commitment or obligation to the incentive program is linked to the available compensation options 140 wherein in order to select a particular type or quantity of compensation 140, the participant 115 must agree to remain enrolled in the incentive program for a minimum term or duration.

When the participant 115 has agreed upon the compensation dividend 140 of his/her interest, the participant 115 is enrolled 540 in the incentive program and the process 500 completed. In one aspect, the CTB 105 may desirably require the participant 115 to complete a form or declaration in which the participant 115 is obligated to participating in the incentive program and bound by the terms agreed upon by both the CTB 105 and the participant 115. Participant enrollment in the incentive program thus may constitute an agreement or obligation between the CTB 105 and the participant 115 wherein the CTB 105 agrees to provide the participant 115 with compensation 140 in exchange for the participant's willingness to conduct a number of transactions or spending a designated quantity of money with merchants within the affiliate base 145.

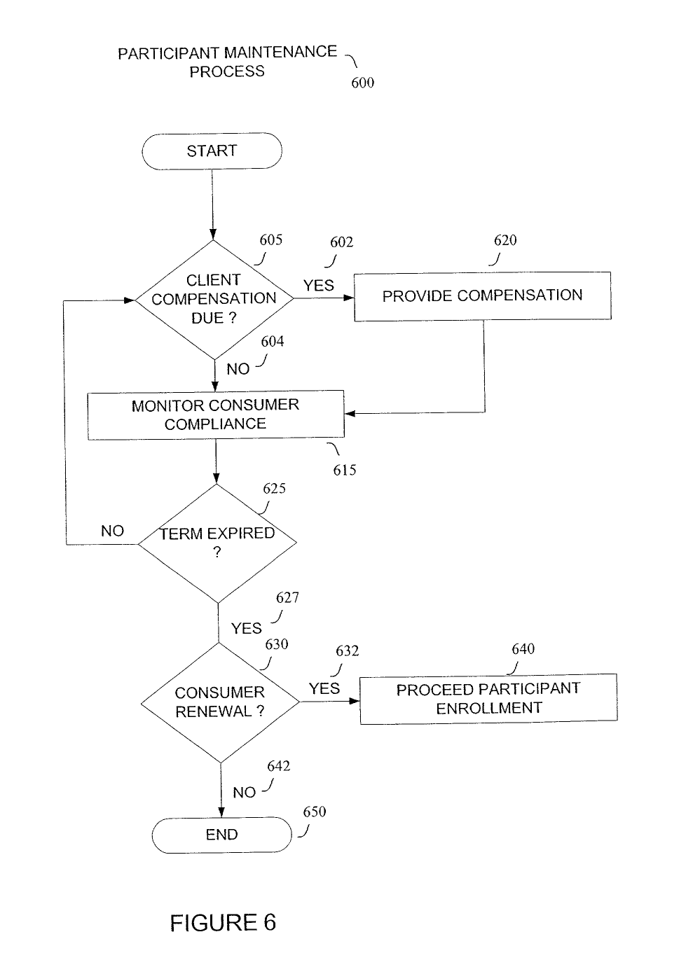

As shown in FIG. 6, subsequent to the participant's enrollment 540 in the incentive program, a participant maintenance process 600 monitors compensation distribution and consumer compliance. In one aspect, the participant maintenance process 600 determines whether the CTB 105 owes 605 the participant 115 compensation. Any compensation 140 that is due 602 is provided 620 to the participant 115 in accordance with the agreement of terms and conditions of the consumer benefit package selected. If no compensation is due 604, the participant's compliance with the terms of the incentive program is monitored 615. The monitoring of participant compliance 615 is an important feature of the participant maintenance process 600 which insures that the participant 115 complies with the terms and conditions which were agreed upon when the participant 115 was enrolled 540 in the incentive program. Compliance monitoring 615 further insures that affiliates 110 of the CTB 105 will receive anticipated patronage, transaction activity, in exchange for the payments of an agreed upon price 120 each affiliate 110 provides the CTB 105.

During the term of enrollment of the participant, the CTB 105 compensates 620 the participant 115, as required, until such time as the participant's term is determined to be expired 625. Upon expiration of the participant term 627, the participant 115 may choose to renew his commitment 630 with the CTB 105. In one aspect, upon consumer renewal 632, the participant maintenance process 600 proceeds back 640 to the participant enrollment process 500 where the participant 115 may select new compensation dividends 140 with different terms and conditions. Should the participant 115 choose not to renew his enrollment 642, the participant 115 is released from the incentive program and the consumer maintenance process 600 is terminated 650.

In one aspect, the CTB 105 and participant 115 may re-evaluate their agreement prior to the expiration 627 of the term of the agreement. This re-evaluation may be used, for example, to alter the terms of the agreement and provides a mechanism for both the CTB 105 and the participant 115 to modify the form of the compensation dividend 140. Furthermore re-evaluation may to accommodate changes in the participant's CPP 210 or participant desires as to the type of compensation 140 which he receives.

It is conceived that by using the aforementioned system and methods for transacting business, a network of merchants 110 and consumer participants 115 can be formed. In one aspect, this network desirably links each merchant 110 to the CTB 105 permitting the exchange of information to monitor, manage, and administrate the mercantile activity 132 of the consumer participants 115. Furthermore, the interaction of the participants 115 with the merchants 110 can be identified so as to permit the tracking of consumer transactions with the merchants 110. In one aspect, the transactions may be paid for by various methods such as; credit card, check, cash, or any other recognizable form of payment for the goods and service offered by the merchants 110. In another aspect, consumers 115 may be identified using an account number or membership card that may permit both the merchant 110 and the CTB 105 to identify consumer transactions.

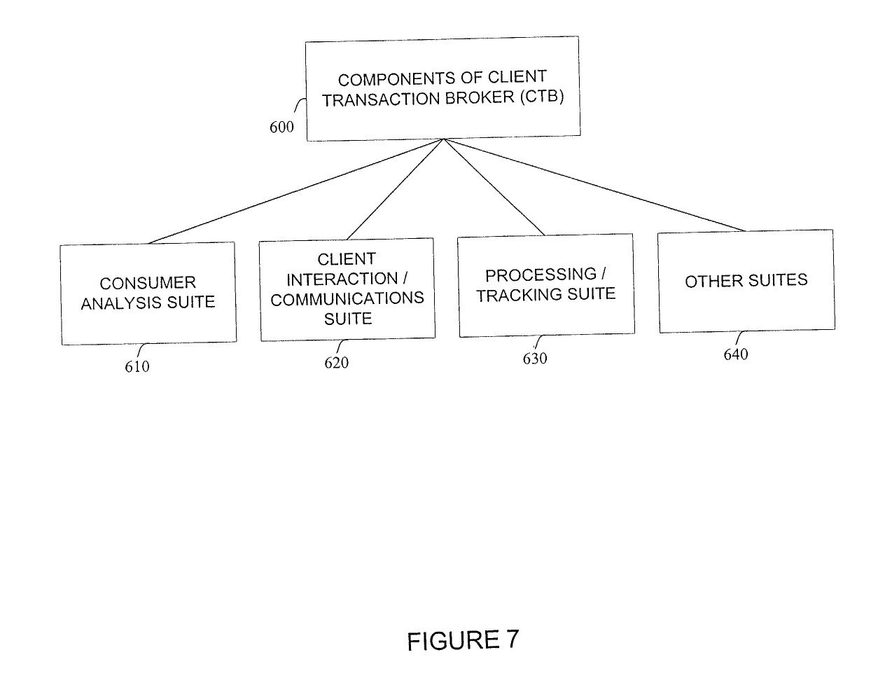

FIG. 7 illustrates a more detailed overview of the client transaction broker system for implementing the system and methods of incentive driven commerce. In one aspect, the computerized system comprises a plurality of software components 600 which facilitate the administration of the CTB 105. Each component desirably comprises a suite or group of computerized functionality's integrated into a singular system which can be accessed by the CTB 105 to manage transaction, compensation, and investment activities for the both the consumer base 155 and the affiliate base 145.

One component of the computerized system comprises a consumer analysis suite 610. This component 610 receives input data necessary to assess the consumer purchasing potential or buying power score 210 and performs the analysis of the CPP 205 based on the input data. One of the data inputs may be a break down of the total disposable income available to the consumers and represented by entering various percentages of the total disposable income being spent on various expense categories. For example, if the total income is $50,000, and 30% of that is being spent mortgage, 20% on vehicle leasing/purchases, 10% on insurances, 10% on groceries, 15% on traveling/vacations etc., a set of different formulas will be used to figure out the profitability and the cash value of each consumers buying power. For example there will be a different formula for figuring out the potential profitability in the money a consumer is spending on insurance or travel or mortgage. In case of a mortgage, it will be essential to know the interest rate, loan duration, ratio of the interest and the principle yet to be paid. Based on this information, the system will calculate the total value and the profit margin that the lender, who is serving the loan, is dealing with. The CTB 105 will also consider a normal or usual interest rate and profit margin on each kind of a loan. The CTB 105 will also need to decide what will be more beneficial to its consumers 115 to negotiate a sale. Regardless of which option is exercised, the CTB will desirably be profitable and pass at least a portion of the revenue received on to the consumer 115. Based on this information, the CTB will be in a position to bargain and sell to lenders the guarantee that each loan under discussion will not be refinanced or sold to any other lender for an agreed upon period of time. Similar methods implemented with different formulas will be applied to calculating the value of insurance, vacation spendings etc.

The consumer analysis suite 610 further comprises at least one database or other appropriate data structure for organizing the participant information. The consumer analysis suite 610 additionally facilitates functions such as searches, sorts, editing, and processing of participant information which may be subsequently used in the consumer evaluation method 500 and the consumer maintenance method 600.

Another component of the computerized system may comprise a client interaction and communications suite 620. This component 620 may be accessed by the CTB 105 or the participant 115 and permits interaction with the software system to view stored information. This suite 620 additionally possesses functionality to permit the CTB 105 or the participant 115 to review the participant's account and update the information as needed. Furthermore, the client interaction and communications suite 620 may comprise a link or connection to various the merchants of the affiliate base 145.

In one aspect, the CTB 105 may utilize an online store or merchandizing feature that permits participants 115 to transact with affiliates 110 through the CTB 105. Thus, participants 115 can meet the obligation of transacting with affiliates 110 by either interacting with the affiliates 110 directly or working through the computerized system hosted by the CTB 105.

The client interaction and communications suite 620 can be further implemented using a communications medium such as the Internet. In this system the participant 115 uses a web browser to view web pages of an online store maintained by the CTB 105 or the affiliates 110.

Yet another component of the computerized system may comprise a processing and tracking suite 630. This component 630 is used to register participant transactions with the affiliates 115 and monitor compliance with the terms and conditions set forth by the agreement between the CTB 105 and the participant 115. In one aspect, the tracking suite 630 may be linked to each merchant wherein participant transactions with the affiliate 110 are automatically recognized and processed. The tracking suit 630 may further calculate the dividends 120 each affiliate 110 owes the CTB 105 based on the participant transactions. This feature insures that both participant compliance and affiliate compliance are monitored and maintained by the CTB 105. For example, the tracking suit 630 may monitor the return dividend 120 distribution to the CTB 105 based on participant transaction activity to insure that the CTB 105 is receiving the proper quantities of return dividends 120 from the affiliates 110. Additionally, the tracking suit 630 may monitor the participant transaction activity to insure the quantity or types or transactions agreed upon by the participant are performed. Thus, shortfalls in return dividend distribution and transactional activity can be readily identified and corrected by the CTB 105. In the case of the participant not meeting his obligation to perform the agreed upon mercantile activity 132, the CTB 105 may require the participant to repay the CTB 105 at least a portion of the compensation dividend 140.

In another aspect, the processing and tracking suite 630 may notify the CTB 105 of compensation 140 which is owed over the term of enrollment of the participant 115. This component 630 may additionally be used to automate the compensation process by distributing appropriate compensation 140 as it becomes available or is needed to facilitate the compensation administration of large numbers of participants 115. Yet still other components of the processing and tracking suite 630 may insure that various aspects relating to the transaction activity, for example, the process of confirming consumer's identification information, codes, passwords, cards may be performed to ensure that the relevant information connected with the transaction is entered into the system. The system will further ensure that if the consumer's amount of actual buying power is less than the consumers promised buying power, corrective actions are carried out to adjust for the difference or deficit and the consumer may be informed and asked to pay back at least a portion of the difference. The system may further insure that all agreed upon return dividends 120 are paid by the affiliate merchants 110 to the CTB 105 and other conditions and arrangements are met.

The software system of the CTB 105 may further comprise other suites or components 640 to provide other functionalities that desirably facilitate the organization, monitoring, maintenance, investing, payments and administration connected buying and selling buying powers and perform other functions in the clearing house. For example, a storage suite may be used to save and retrieve information related to the various participants 115 affiliates 110 and various transactional and functional activities of the system, permitting the CTB 105 to manage large quantities of information.

The foregoing system and methods for transacting business describe an incentive-driven process which has features and flexibility not found in conventional methods for improving commerce. In one aspect, the incentive-driven process desirably reduces the financial burden and costs associated with increasing customer patronage. This feature may be achieved by delegating the responsibility of administering and maintaining the incentive-driven process to the CTB 105. By interacting with a plurality of affiliates 110, the CTB 105 can more efficiently administer and maintain the incentive-driven process for a reduced cost compared to that of each merchant acting independently.

In another aspect, by pooling merchant or affiliate businesses in the affiliate base 145, the CTB 105 may offer greater flexibility in the types of transactions which the participant is obligated to conduct in order to receive the compensation dividends 140. Furthermore, the utilization of the affiliate base 145 provides a method for the CTB 105 to increase the size of the compensation dividend 140 relative to the incentives which can be reasonably provided by individual merchants. The increased incentive size presents a more attractive lure to potential consumers and thus may entice more consumers into transacting with the individual merchants. Furthermore, the increased size and quantity of the compensation dividend 140 may create a lasting or substantial impact on the participant's lifestyle in a manner which cannot be accomplished using existing method of transacting business.

Another feature of the present method of transacting business permits the CTB 105 to provide the participant 115 with the compensation dividend 140 prior to the participant 115 transacting with the affiliates 110. Up-front compensation 140 in this manner represents an improved method of attracting consumers 115 to the affiliates 110 and satisfies the consumer's need for immediate gratification.

In one aspect, the system and methods present herein permit the participant 115 to leverage or sell his present and future buying power in exchange for compensation 140. Furthermore, by aggregating the total purchasing power of the participant 115 a more significant or desirable incentive may be offered.

Although the foregoing description of the invention has shown, described and pointed out novel features of the invention, it will be understood that various omissions, substitutions, and changes in the form of the detail of the apparatus as illustrated, as well as the uses thereof, may be made by those skilled in the art without departing from the spirit of the present invention. Consequently the scope of the invention should not be limited to the foregoing discussion but should be defined by the appended claims.

What is claimed is:

1. A system for distributing dividend income to a plurality of consumer participants based upon their transaction of business with a plurality of affiliated partners, the system comprising:
a plurality of encoded membership identifiers that uniquely identify each of the consumer participants;
a plurality of networked identification devices which are distributed to each of the affiliated partners wherein each of the plurality of networked identification devices uniquely identify one of the plurality of consumer participants, wherein each of the plurality of networked identification devices record and transmit participant transaction information identifying a particular membership identifier and transaction information corresponding to mercantile activity the consumer participant engaged with the affiliated partner;
a client transaction broker system that includes an associated customer information database having a record for each of the plurality of consumer participants, wherein the client transaction broker system receives the participant transaction information and determines a compensation dividend to be afforded to the consumer participant based upon their transaction with the affiliated partner such that the client transaction broker system updates the information within the record corresponding to the consumer participant and wherein the client transaction broker system further evaluates the consumer participant's purchasing power to determine the compensation dividend and wherein the client transaction broker system uses a return dividend provided by the affiliated partner in exchange for participant mercantile activity to fund the consumer compensation dividend.

2. The system for distributing dividend income of claim 1, wherein the membership identifiers comprise encoded identification or membership cards.

3. The system for distributing dividend income of claim 2, wherein the networked identification devices comprise card reading machines which interpret information contained in the encoded identification cards and membership cards.

4. The system for distributing dividend income of claim 1, wherein the compensation dividend further comprises a guaranteed single sum payment.

5. The system for distributing dividend income of claim 4, wherein the payment is selected from the group consisting of money, goods, and services.

6. A computerized system for transacting business, the system comprising;
an analysis component which:
(1) quantities the total purchasing power of a plurality of consumer participants wherein the purchasing power reflects each participant's ability to engage in mercantile activity;
(2) analyses the purchasing power of each consumer participant and determines a least one compensation dividend to provide the consumer participant with;
(3) allocates the compensation dividend for each consumer participant in exchange for an estimable quantity of mercantile activity; and
a tracking component which monitors and tracks the mercantile activity of the consumer participant.

7. The computerized system for transacting business of claim 6, wherein the compensation dividend further comprises a guaranteed single sum payment.

8. The computerized system for transacting business of claim 7, wherein the payment is selected from the group consisting of money, goods, and services.

9. A method of transacting business, the method comprising:
enrolling a plurality of consumer participants in an organization wherein each consumer participant engages in mercantile activity of estimable quantities;
determining an estimated aggregate of the total purchasing power of the plurality of consumer participants for the mercantile activity;
selling the consumers buying power to one or more affiliated partners so that the affiliated partners will agree to buy at least a portion of the buying power of the consumer and pay the agreed upon price to the organization for the mercantile activity of the consumer participants wherein the return dividend is calculated based, at least in part, on the determined estimated aggregate of the total purchasing power;
obligating the consumer participants to engage in mercantile activity with the one or more affiliated partners; and
distributing compensation to the consumer participants that is derived from the return dividends received by the organization from the affiliated partners, wherein the compensation is based upon the level of mercantile activity with the one or more affiliated partners.

10. The method of transacting business of claim 9, wherein the mercantile activity engaged in by each consumer participant comprises purchasing goods and services from the affiliated partners.

11. The method of transacting business of claim 9, wherein the mercantile activity engaged in by each consumer participant comprises purchasing goods and services from the organization.

12. The method of transacting business of claim 9, wherein the mercantile activity engaged in by each consumer participant comprises performing commercial transactions with the affiliated partners.

13. The method of transacting business of claim 9, wherein determining the estimated aggregate of total purchasing power of consumer participants comprises evaluating a plurality of consumer factors which combine to construct a personal and financial profile of the consumer participant.

14. The method of transacting business of claim 13, wherein constructing the personal and financial profile of the consumer participant comprises evaluating consumer factors related to income of the participant.

15. The method of transacting business of claim 13, wherein constructing the personal and financial profile of the consumer participant comprises evaluating consumer factors related to financial resources of the participant.

16. The method of transacting business of claim 13, wherein constructing the personal and financial profile of the consumer participant comprises evaluating consumer factors related to financial obligations of the participant

17. The method of transacting business of claim 13, wherein constructing the personal and financial profile of the consumer participant comprises evaluating consumer factors related to a purchasing habits of the participant.

18. The method of transacting business of claim 13, wherein constructing the personal and financial profile of the consumer participant comprises evaluating consumer factors related to a personal information of the participant.

19. The method of transacting business of claim 9, wherein the estimated aggregate of total purchasing power can be used to assess both short-term and long-term mercantile activity.

20. The method of transacting business of claim 9, wherein the compensation is determined by evaluating a plurality of compensation factors which customize the compensation dividend for each participant.

21. The method of transacting business of claim 20, wherein determining the compensation comprises evaluating the purchasing power of the consumer participant.

22. The method of transacting business of claim 20, wherein determining the compensation comprises evaluating a duration related compensation factor.

23. The method of transacting business of claim 20, wherein determining the compensation comprises evaluating a commitment related compensation factor.

24. The method of transacting business of claim 20, wherein determining the compensation comprises evaluating a flexibility related compensation factor.

25. The method of transacting business of claim 20, wherein determining the compensation comprises evaluating a need related compensation factor.

26. The method of transacting business of claim 20, wherein determining the compensation comprises evaluating a desire related compensation factor.

27. The method of transacting business of claim 9, wherein distributing the compensation comprises distributing a profit sharing dividend to a party designated by the consumer participant.

28. The method of transacting business of claim 9, wherein distributing the compensation comprises distributing a product pricing dividend to a party designated by the consumer participant.

29. The method of transacting business of claim 9, wherein distributing the compensation comprises distributing an earned revenue dividend to a party designated by the consumer participant.

30. The method of transacting business of claim 9, wherein distributing the compensation comprises distributing a pre-allocated compensation dividend to a party designated by the consumer participant.

31. The method of transacting business of claim 9 wherein distributing compensation comprises distributing a loan dividend to a party designated by the consumer participant.

32. The method of transacting business of claim 9 wherein distributing the compensation comprises distributing a reward dividend to a party designated by the consumer participant.

33. The method of transacting business of claim 9 wherein distributing the compensation comprises distributing a contribution dividend to a party designated by the consumer participant.

34. The method of transacting business of claim 9, wherein enrolling the plurality of consumer participants further comprises;
acquiring consumer participant information;
reviewing compensation dividends with the consumer participant;
analyzing the purchasing power of the consumer participant; and
selecting a compensation dividend;

35. The method of transacting business of claim 9, wherein distributing the compensation to the consumer participant further comprises;
determining when the compensation dividend should be distributed to the consumer participant;
monitoring the obligated mercantile activity of the consumer participant to insure compliance; and
determining when a term or expiration date of compensation dividends has elapsed.

36. The method of transacting business of claim 9, wherein at least a portion of the method is executed within a computerized framework.

37. A method for conducting incentive-driven commerce, the method comprising:
quantitating the present and future buying power of a consumer participant;
providing a compensation dividend in exchange for the sale of the consumer participant's present and future buying power wherein the compensation dividend is calculated based on the present and future buying power of the consumer participant;
obligating the consumer participant to engage in mercantile activity with at least one affiliated merchant in exchange for the compensation dividend; and
acquiring a return dividend from the affiliated merchants, wherein the return dividend is based, at least in part, upon the mercantile activity of the consumer participant.

38. The method of conducting incentive-driven commerce of claim 37, wherein quantitating the present and future buying power of a consumer participant further comprises assigning a score to an aggregate of the present and future buying power of the consumer participant.

39. The method of conducting incentive-driven commerce of claim 38, wherein the score is used to determine the type and amount of the compensation dividend.

40. The method of conducting incentive-driven commerce of claim 37, wherein the buying power of the consumer participant is quantitated by assessing the personal and financial profile of the consumer participant and evaluating consumer factors related to income of the participant.

41. The method of conducting incentive-driven commerce of claim 37, wherein the buying power of the consumer participant can be used to assess both short-term and long-term mercantile activity.

42. The method of conducting incentive-driven commerce of claim 37, wherein the compensation dividend is provided to the consumer participant in an up-front manner prior to the consumer participant engaging in mercantile activity with the affiliate merchants.

43. The method of conducting incentive-driven commerce of claim 37, wherein the compensation dividend is provided to the consumer participant after the consumer participant has engaged in mercantile activity with the affiliate merchants.
